(19) United States
(12) Patent Application Publication
(10) Pub. No.: US 2012/0066957 A1
(43) Pub. Date: Mar. 22, 2012

(54) DEVICE FOR SIGNALING A PRESENCE OF ANIMALS INSIDE UNITS FOR MONITORING ANIMALS, AND A RELATIVE MONITORING UNIT

(75) Inventor: Paolo Gaibotti, Campogalliano (Modena) (IT)

(73) Assignee: O.S.D. GRUPPO ECOTECH S.R.L., Campogalliano (Modena) (IT)

(21) Appl. No.: 13/232,922

(22) Filed: Sep. 14, 2011

(30) Foreign Application Priority Data
Sep. 16, 2010 (IT) RE2010A000072

(51) Int. Cl. A01M 23/16; A01M 23/00

(52) U.S. Cl. 43/60

(57) ABSTRACT

A device, for signaling a presence of animals inside monitoring units for locating animals, of a type having a box body configured to contain animals and provided with at least two access ports and respective mechanical mechanism for opening and closing the access ports. The device includes a detecting and signaling device of the presence of at least one animal inside the box body. The detection and signaling device can be activated to open and close by a switch element (103) which can be associated internally to the box body and which can be shaped in such a way as to be activated by a plurality of mechanical mechanisms that are mobile with respect to the box body and located internally thereof.

### RELATED APPLICATIONS

The present application hereby claims priority under 35 U.S.C. Section 119 to Italian Patent application number RE2010A000072 filed Sep. 16, 2010, the entire contents of which are hereby incorporated by reference.

### FIELD OF INVENTION

The invention concerns a device for signaling the presence, i.e. the passage or capture of animals inside animal monitoring units, and the relative monitoring unit, in particular for locating rodents or similar animals.

In greater detail, an advantageous application of the invention concerns a device for signaling the presence, or the capture of animals inside traps, and the relative trap, for locating and catching rodents or similar vermin.

A further, equally advantageous application of the invention concerns a device for signaling the presence or passage of animals inside monitoring units of a box type and the relative monitoring unit, for temporarily locating such animals, whether verminous or not, in a predetermined positioning area of the monitoring unit.

### BACKGROUND

As is known, eliminating unwelcome vermin, such as rodents, for example mice, rats or the like, from environments is a significant problem in dwellings and workplaces. This is especially the case for businesses requiring a particularly rigorous level of hygiene and health control and which in this respect are subject to stringent rules (HACCP).

Workplaces of this nature, which require a high standard of control, are known to use verminous animal monitoring units for locating such animals, for example box-type traps. These traps entice the animals to enter a box body, through which the animal can pass or in which it can remain trapped.

In particular, use of an improved type of box trap is known—the multiple-catch trap—which provides two or more entry ports for animals and can catch one or more verminous animals at a time.

It is clearly highly advantageous to use this type of trap exhibiting several entry ports, since this avoids the use of poisonous substances, which are often banned within environments such as food businesses or the like. Since the traps are of the box type, they can—if the access ports are provided with no-return means—enable segregation of the captured animal within the box body, thus providing obvious advantages in terms of hygiene for the capture or monitoring environment.

However this type of trap requires periodical controls at more or less short time intervals, to ascertain whether animals are present inside the box body.

To facilitate this task, devices of the type described in European Patent No. EP 1 059 031 are known, which signal the presence of animals inside animal traps for vermin.

The above-mentioned patent provides a detailed description of a first type of device for detecting animals in animal traps, which comprises a box body provided with two access ports. The access port is provided with a no-return mechanism comprising a plate which tilts on a central pivot. A switch is used to detect the presence of animals in the trap. The switch, which is activated by the lowering of the tilting plate, is connected to a circuit which signals the presence of the animals.

In this known type of device, then, each access port comprises a push-button for the opening of the port, thus also signaling entry of the captured verminous animal into the box body.

This first type of known devices is however not free of drawbacks. Among the drawbacks is the fact that the presence of several push-buttons in the box body of the trap complicates the wiring between the said push-buttons and the signaling circuit. This is because conduits must be provided, in the box constituting the trap, for the passage of the electrical cabling connecting the various push-buttons and the circuit, and this cabling must be hidden from, and inaccessible to the animals.

Further (as described in European Patent 1 350 430, assigned to the same owner of the previously-mentioned European Patent 1 059 031) the push-buttons must be protected by protection means, or must in any case be arranged in positions which are not directly accessible to the animals, in order to prevent push-buttons from being damaged by the animals, which would compromise their correct operation.

Therefore for this first type of known device, particular design features must be adopted when designing the traps such as to ensure that they function correctly over time.

A second type of known device which attempts in part to obviate these drawbacks is again described in European Patent No. 1 059 031. Here the detection means comprise one or more elongate elements which are activated by the animals' movements inside the traps. These elements may be arranged either vertically or horizontally.

In the first case, one end is connected to the device which is arranged on the lid of the trap and contains the detection means, while the other end remains raised slightly from the bottom, in such a way as to be activated by the movements of the animals.

In the second case, one end is connected to the edge of the trap while the other is arranged in the central area, at a height enabling it to be activated by the movements of the animals.

However this second known type of device is also not free of drawbacks, since although such devices are arranged inside the box and are interposed between the access ports of the animals into the box body, signaling of the presence of the animals depends on whether or not the animals interacts accidentally with the detection rod extending into the box. It is possible for this not to happen at all.

Consequently the signaling device would be ineffective and entail for example hygiene and health-related drawbacks caused by dead animals remaining inside the traps.

The abovementioned European Patent proposes a further solution to obviate this drawback, whereby optical means detect the presence of the animals inside the box. However, such solutions appear to be economically disadvantageous, and extremely complicated from a practical point of view.

### SUMMARY

An aim of the invention is to obviate the abovementioned drawbacks regarding presence-detection devices of a known type by providing a device for signaling the presence of animals inside animal monitoring units: the device enables the entry of such animals into the monitoring unit via each access port thereof to be detected with certainty, while at the same time reducing the space occupied by cabling and equipment protecting the detection components.

An aim of the device of the invention is to ensure a high level of detection efficiency.

A further aim of the invention is to ensure that the detection device of the invention adapts easily to, and is compatible with monitoring units, for example commercially available traps, even after the traps have been produced and marketed, thus enabling traps to be transformed—even in phases subsequent to the marketing of the traps—into improved traps, which are capable of signaling the presence of an animal.

At the same time, in the case of defective functioning, damage or wear of these components, the electronic components can be replaced without difficulty.

A further aim of the invention is to enable and to facilitate operations for cleaning and disinfecting the box, in such a way that these operations do not cause damage to the electronic components.

A further aim of the invention is to provide a structure which is simple, relatively easy to implement in practical terms, easy even for unskilled or not particularly expert operators to put in place and install, safe in use, effective in operation, and relatively inexpensive.

These aims are attained by the characteristics of the invention as disclosed in the independent claim 1. The dependent claims delineate preferred and/or particularly advantageous aspects of the invention.

### BRIEF DESCRIPTION OF THE DRAWINGS

Further characteristics and advantages of the invention will emerge from the following description, which is provided by way of a non-limiting example of an embodiment thereof, with the aid of the appended figures of the drawings.

FIG. 1 is an axonometric view of a trap with two access ports, which is provided internally with a first embodiment of a device for signaling the presence of animals within it, according to the invention.

FIG. 2 illustrates a detail of the device of FIG. 1.

FIG. 3 is an exploded view of the switch element of the signaling device of the invention of FIG. 1.

FIG. 4 is a plan view from above of the switch element of FIG. 3.

FIG. 5 is an exploded view of a second embodiment of the switch element of the signaling device according to the invention.

FIG. 6 is a plan view from above of the switch element of FIG. 5.

### DETAILED DESCRIPTION OF THE PREFERRED EMBODIMENTS

With reference to figures from 1 to 4, reference numeral 1 denotes a monitoring unit for locating animals, which comprises a box body 2 destined to contain such animals.

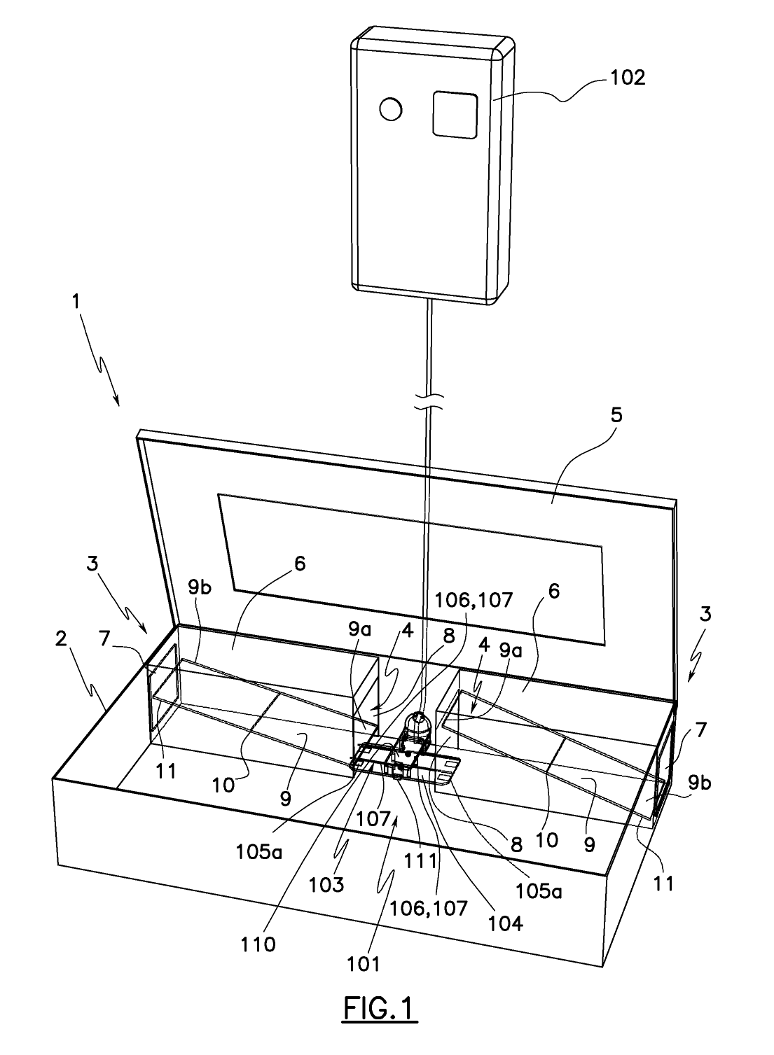

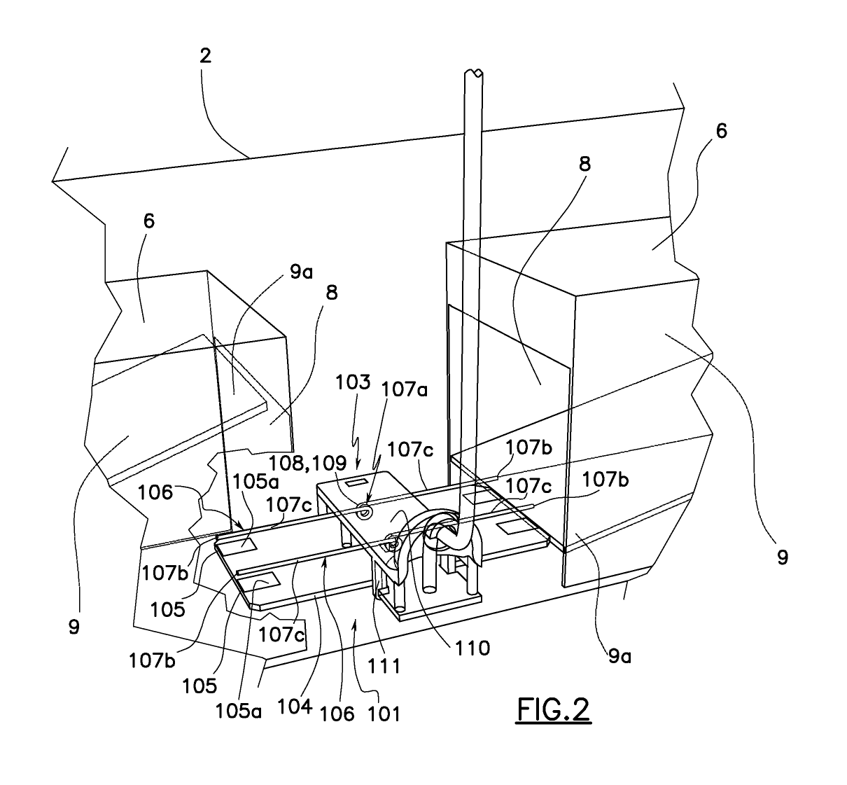

In the example shown in FIGS. 1 and 2, the monitoring unit 1 is a trap for catching vermin. However the monitoring unit 1 can simply be destined to detect the passage of the vermin, without trapping them inside the box body 2.

The box body 2 comprises at least a pair of access ports 3 enabling animals to access the interior of the box body.

The box body 2 further comprises mechanical mechanisms 4 for opening and closing the access ports 3.

The trap 1 also comprises a lid 5 which is hinged to the box body 2 and opens and closes the box body 2.

The monitoring unit, in this particular case the trap 1, comprises a device for signaling the presence of animals within the box body 2, the device being denoted in the figures by reference numeral 101.

The device 101 comprises a detection and signaling device 102, that detects and signals the presence of least a verminous or non-verminous animal inside the box body 2.

The detection and signaling device 102 comprises, for example, at least an electronic circuit for activating an audio or visual signaling device, or cable or wireless transmitter to transmit a presence signal, which is associated externally to the box body 2 of the trap 1, or connected remotely to the electronic circuit.

The electronic circuit can be opened or closed by a switch element 103 which is destined to detect the presence of the animals in the box body 2 automatically and can be activated by mechanical mechanism 4.

In particular, in relation to the aims of the invention, the device 101 comprises a switch element which can be associated internally to the box body 2.

Further, the switch element 103 is shaped in such a way as to be activated by each of the mechanical mechanism 4 of the pair of access ports 3.

The switch element 103 is intercepted, by contact, by each of the mechanical opening and closing member 4 of the pair of access ports 3 exhibited by the box body.

The switch element 103 advantageously comprises at least a plate 104 which is provided with conductive tracks 105 connecting to the electronic control circuit.

The plate 104 is removably associated to the interior of the box body 2. Purely by way of example, the plate 104 can be associated to the box body 2 using interlocking members, temporary fixing organs or can simply be rested on the bottom of the box body 2.

The tracks 105 are associated to the plate 104. They may be for example printed, silkscreen-printed or solidly associated to the plate 104 by means of any manufacturing method whatsoever, and are destined to be contacted by at least a conductive element 106, for example in such a way as to close the electronic circuit, in order to be accessible by the conductive element 106.

In the upper perimeter zone of the plate 104 the tracks 105 exhibit a contact portion 105a which is destined to be contacted by the conductive element 106.

For example, several tracks 105 may be provided and associated to the plate 104, the tracks 105 being destined to give rise to circuit branches which are in series or in parallel according to the signaling requirements and the complexity of the electronic circuit.

The conductive element 106, in particular, is mobile between a non-contact position and a configuration of contact with the tracks 105 and can be changed between these configurations by each of the mechanical mechanisms 4, which are mobile internally of the box body 2.

Advantageously, in the embodiment shown in the figures, the conductive element 106 is associated to the plate 104.

However this does not exclude alternative and equivalent embodiments of the switch element 103, for example those in which the conductive element is solidly associated directly to the mechanical mechanisms 4 and is such as to contact the tracks 105 provided on the plate 104.

Alternatively, a plurality of conductive elements 106 can be provided, for example switches or other elements, which are supported by the plate 104 and can be activated by each of the mechanical mechanisms 4 of the respective access ports 3.

The conductive element 106 advantageously comprises at least a conductive filament 107, which is superiorly associated to the plate 104 at an intermediate zone 107a of the filament, the intermediate zone 107a being included between two ends 107b of the filament 107.

The filament 107 defines two tracts 107c which diverge from the intermediate zone 107a towards the ends 107b, and are kept separate from the plate 104 by an elastic member 108.

Each of the mechanical mechanisms 4 is destined to contact one of the ends 107b of the filament 107 in order to move the respective tract 107c of the filament from the no-contact configuration to the contact configuration with the tracks 105, in opposition to the elastic member 108.

In this particular embodiment, the electronic circuit is of the type which is normally open, and which the conductive element 106 closes when the presence of a pest is detected inside the box body 2. However, this does not exclude different equivalent configurations, in which the electronic circuit is of the type which is normally closed, and is opened when the presence of a pest is detected inside the box body 2.

Advantageously, to facilitate contact of the filament 107 with the mechanical mechanisms 4, the projection of the end 107b of each of the tracts 107c of the filament 107 on the plane defined by the plate 104 is external of the plate 104.

Each of the access ports 3 of the monitoring unit 1 comprises at least a tunnel 6.

In particular, the tunnel 6 is provided with a first access mouth 7 facing towards the outside of the box body 2 and giving access to the tunnel 6, and a second access mouth 8 facing towards the interior of the box body 2 for accessing the box body 2.

The mechanical mechanisms 4 can be operated to selectively open the first and second access mouths, 7 and 8, and comprise at least an inclined plane 9, which is interposed between the first access mouth 7 and the second access mouth 8, and which is tiltingly associated to the side walls of the tunnel 6 at a substantially central pivot 10.

The first end 9a of the plane 9 is proximal to the second access mouth 8 and is in particular destined to contact the switch element 103, and even more particularly the end 107b of the tract 107c of the filament 107, which tract 107c is facing towards the second access mouth 8, at the opening of the second access mouth, i.e. where the plane 9 tilts under the effect of the passage of the animal, whether a pest or not, from the first access mouth 7 to the second access mouth 8 along the tunnel 6.

Further, if the monitoring unit is in particular a trap 1, it comprises no-return devices which are destined to prevent the exit of a pest from the box body 2. The no-return devices, in the particular embodiment shown in the figures, comprise at least a counterweight 11 which is associated to the plane 9 at the second end 9b of the plane 9, the second end 9b being positioned opposite with respect to the first end 9a and being arranged at the first access mouth 7 of the tunnel 6, in order to close the second access mouth 8, by means of the plane 9 tilting in the opposite direction to the direction described herein above for the opening of the second access mouth 8.

The no-return devices can further comprise a flap which is hinged to the plane 9 at the first access mouth 7. This mechanism (not illustrated since of known type to a person skilled in the art) enables rotation of the plane which opens the second access mouth 8 to cause rotation of the flap, thus temporarily occluding the first access mouth 7.

If instead the monitoring unit 1 is not destined to trap the animal, but is simply a unit which is destined to detect the passage of the animal, the unit will not comprise the above-described no-return devices, or possibly the box body will exhibit an exit opening for the animal.

In this way, the monitoring unit simply indicates the presence of or counts the number of passages of the animal in the area where the monitoring unit 1 is installed.

The elastic members 108 of the device 1 comprise at least a flexion spring, each compression leaf of the compression spring being formed by each tract 107c of the filament 107.

In the intermediate zone 107a the filament 107 advantageously comprises at least a coil 109 such as to increase the elastic constant of the filament 107.

In particular, the filament 107 exhibits a longitudinal axis which joins the second access ports 3 of the pair of tunnels 6, and the filament 107 is interposed between the second access ports 3.

In the particular embodiment shown in the figures, the longitudinal axis of the filament 107 is arranged substantially perpendicular to the lie plane of the second access mouths 8.

Further, in this particular embodiment, the conductive element 106 comprises a pair of conductive filaments 107, as described herein above, which are superiorly associated to the plate 104 and are arranged with their respective longitudinal axes substantially parallel, and substantially parallel to the longitudinal axis of the pair of tunnels, which tunnels face each other.

The device 101 further comprises at least a protective bridge 110 which is solidly associated to the plate 104 at the intermediate zone 107a of the filament 107, for example the area of the filament 107 interested by the coil 109, which area will thus be protected and therefore be inaccessible to an animal present in the trap 1.

Note instead that the remaining part of the filament 107, i.e. the end tracts 107c thereof, and much of the upper surface of the plate 104 are in zones which are accessible to being trod on by an animal which has entered the box body 2, without thereby giving rise to problems of damage to the plate 104.

The bridge 110 advantageously comprises engaging members 111 which engage with the plate 104 and are destined to facilitate fastening and removal of the bridge whenever it is necessary to clean the plate 104.

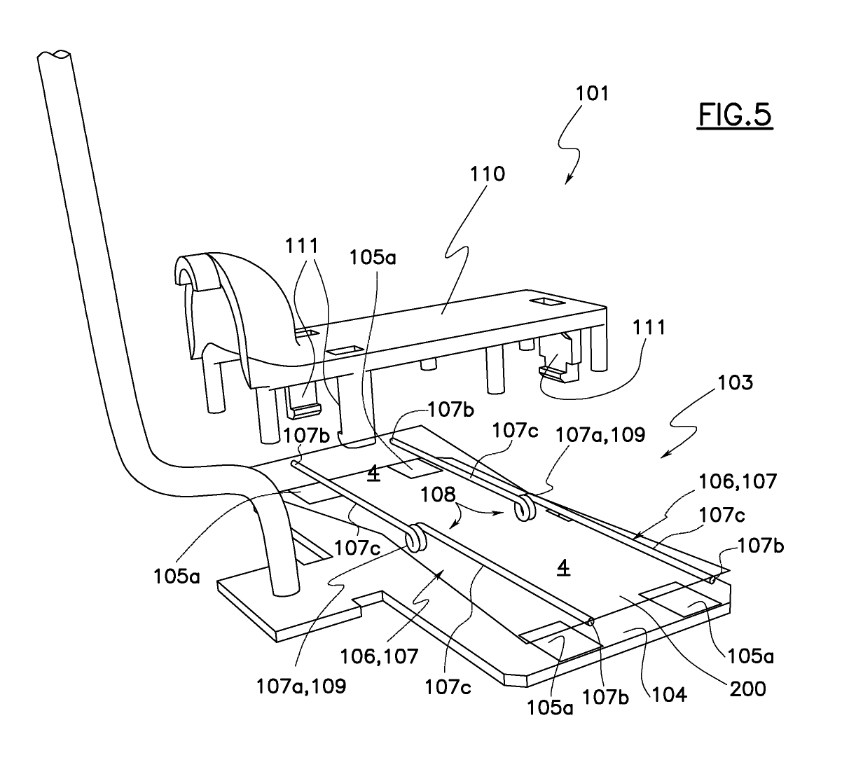

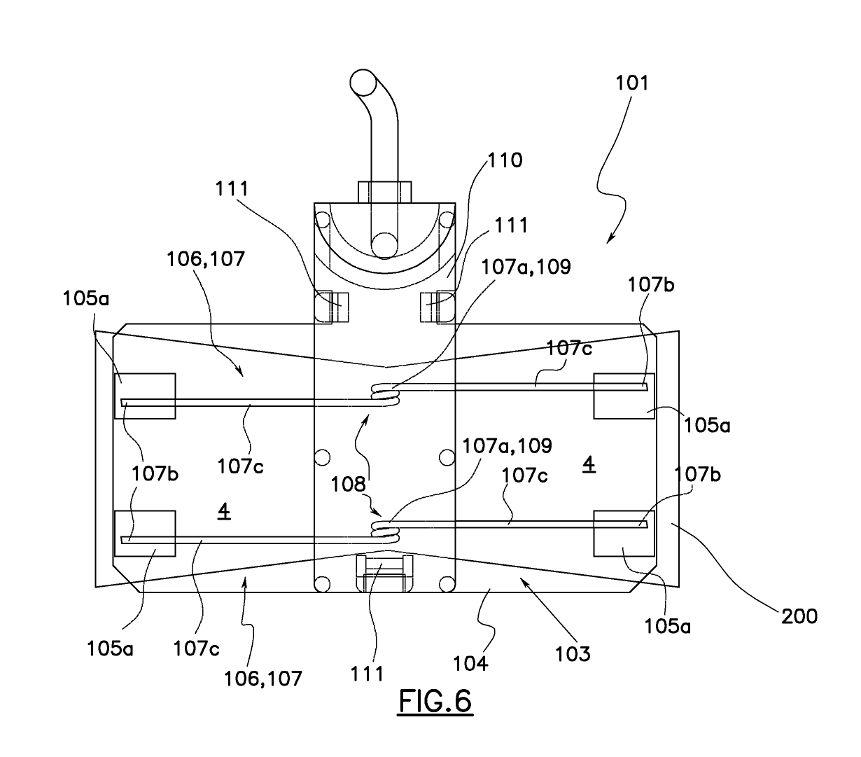

In the alternative embodiment illustrated in FIGS. 5 and 6, a device 101 is shown which can also be used in monitoring locations 1 which are not provided with opening and closing devices for the access ports, for example suitable for passage of animals, or usable for different types of animals than rodents, such as birds or the like, for which no opening and closing mechanism of the access mouths, as described above, is required.

For these applications, the device 101 is entirely similar to the one described above in relation to the first embodiment, to the description of which reference is made (in the figures, the same reference numbers are used for the parts which are common to both devices).

Differently to the first embodiment of the device 101, in the second embodiment the mechanical mechanisms 4, which are mobile with respect to the box body 2 and located internally thereof such as to activate the conductive element 106, further comprise a plate body 200 made of an elastically yielding material, for example electrically insulating or provided with a conductive blade located inferiorly thereof.

The plate body 200 is associated to the plate 104 such that a half-way zone thereof is substantially fastened thereto and arranged in such a way as to cover the conductive element 106.

The half-way zone thus remains interposed between the bridge 110 and the coil 109 of the filaments 107 which constitute the conductive element 106.

The two free flaps, which define the mechanical mechanisms 4, are configured such as each to come into contact with a respective tract of the conductive element 106 (or the tracts 107c and 107b of the filaments 107) and are mobile, thanks to the elasticity of the plate body 200, between a raised position in which they are distanced from the plate 104 and a lowered configuration in which they press the conductive element 106 into contact with the tracks 105.

In practice, the animal which enters the box body 2, and mounts on the device 101, rests on one of the free flaps of the plate body 200 (and therefore even if the conductive element 106 does not enter into direct contact with the animal, an effective activating thereof is possible), which when it lowers with the weight of the animal presses the conductive element 106 onto the tracks 105, activating the device.

The plate body 200 further enables increasing the contact surface on which the animal can activated the device 101 and, therefore, increase the probability that an animal might accidentally/casually cause the closing of the electric circuit (bringing one or more conductive elements 106 into contact with the relative track 105) and activate the detecting and signaling device 102, even in a case of box bodies 2 exhibiting large treadable surfaces.

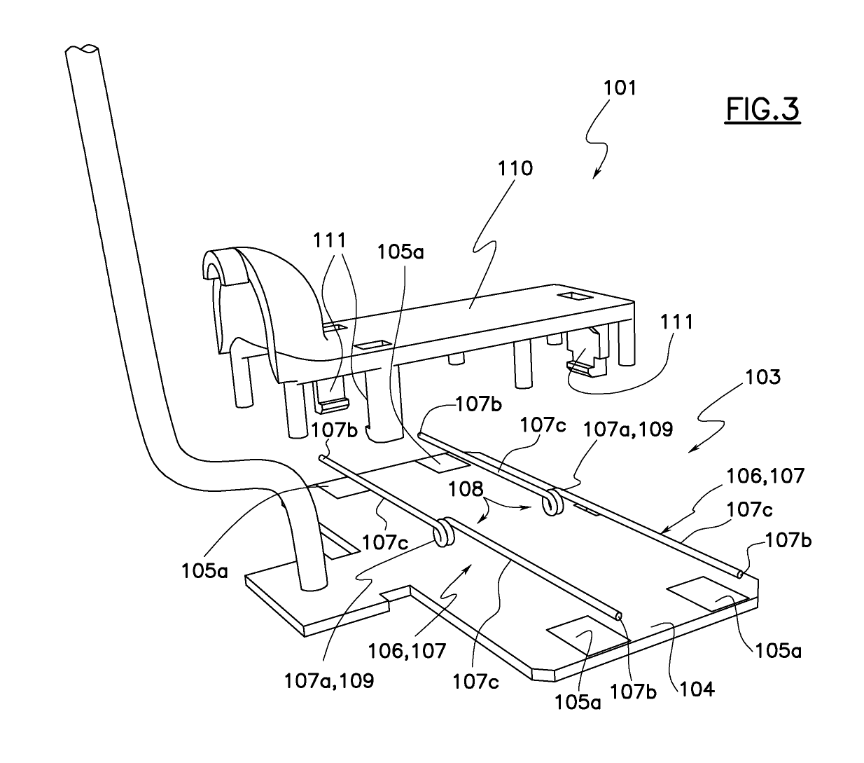

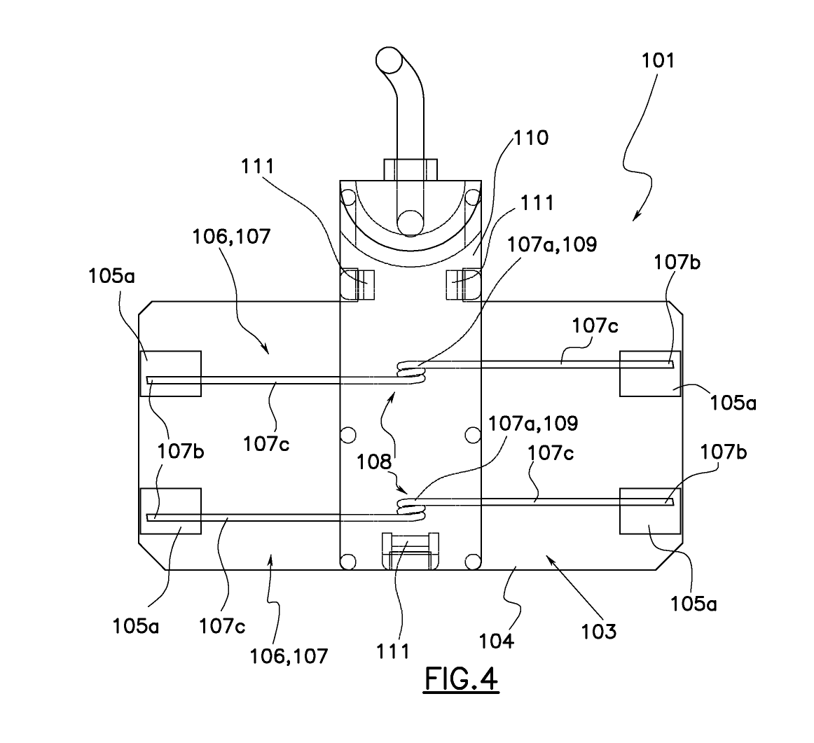

The monitoring unit functions as follows, with particular reference to the trap 1 and the device 101 arranged therein and illustrated in FIGS. 1 to 4.

Once the animal, for example a mouse or a rat, has entered the tunnel 6 of the first access mouth 7 and passed through the tunnel 6, the tilting plane 9 begins to rotate around the pivot 10, gradually closing the first access mouth and opening the second access mouth 8.

When the animal is substantially inside the box body 2 of the trap 1, the plane 9 completes the rotation, thus completely opening the second access mouth.

In this configuration, the plane 9 contacts the end 107b of the tract 107c of the filament 107 which is proximal to the plane 9, moving the filament 107 from the non-contact configuration to the contact configuration, during the rotation of the plane, in opposition to the elastic members 108.

In the contact configuration, the normally open electronic circuit is closed by the conductive element 106 thus activating the detection and signaling device 102, which signal the presence of the animal inside the box body 2 to the operator. Once inside, the animal will be unable to leave the box body 2, which is provided with the no-return device.

The no-return device, i.e. the rising of the plane 9 caused by the counterweight 11, enables the animal to be definitively captured inside the box body 2, and they are activated at substantially the same time as the switch element 103 closes the electronic circuit.

When used as a simple detection unit without catching the animal, the monitoring unit 1 functions in the same way, the only difference being that the animal entering the box body 2 is free to leave it.

Practical experience has shown that the invention described herein achieves the set aims; it must in particular be stressed that the device for signaling the presence of animals inside the animal monitoring unit of the invention allows secure and certain detection of entry of animals into the box body of the unit via each access while at the same time reducing the space utilized for cabling and for the technical elements necessary for protecting the detection-related components.

Further, the monitoring unit exhibiting the abovementioned device has been found to be not only highly effective in terms of detecting, but also easily adapted to and compatible with commercial traps, even after they have been produced in standard formats and placed on the market. At the same time the device guarantees easy replacement of the electronic components, should they malfunction, be damaged or be worn.

Further, it has been found that when fitted to multiple-catch traps, the device facilitates box cleaning and disinfection operations, without these phases possibly causing damage to the electronic components.

The switch element 103 is thus configurable in such a way as to be activated by means of different methods, wherein:
in a first type of activation, on first contact between the plane 9 or the plate element 200 (which exhibits at least a portion facing the filaments 107 realized in a conductive material) and one or more of the filaments 107, the circuit closes and the detection and signaling device 102 is activated. This type is effective for detecting animals even of small size and limited weight;
in a second type of activation, activated by the weight of the animal, the plane 9 or plate element 200 presses one or more of the filaments 107 (or one or more of the tracts 107b and 107c thereof) on the relative tracks 105, activating the detection and signaling device 102.

The invention may exhibit numerous modifications and variants all of which are included within the ambit of the inventive step.

Further, all particulars can be replaced by other technically equivalent elements.

The materials used, as well as forms and dimensions dictated by contingent situations, may vary according to requirements without thereby forsaking the ambit of protection of the claims herein below.

What is claimed is:

1. A device (101), for signaling a presence of animals inside monitoring units (1) for locating animals, comprising a box body (2) configured to contain the animals and having at least two access ports (3), and respective mechanical mechanisms (4) configured to open and close the at least two access ports (3), the device (101) further comprising detecting and signaling device (102), configured to detect and signal a presence of at least one animal inside the box body (2), wherein the detection and signaling device (102) can be activated to open and close by a single switch element (103) internally associable to the box body (2) and is configured such as to be activated by a plurality of mechanical mechanisms (4) that are mobile with respect to the box body and located internally thereof.

2. The device of claim 1, wherein the at least two access ports (3), each include a mechanical mechanism (4), associated to the box body (2), for opening and closing each access port (3).

3. The device of claim 1, wherein the switch element (103) comprises at least a plate (104) provided with conductive tracks (105) and removably associable to an inside of the box body (2), the tracks (105) being configured to be contacted by at least a conductive element (106) which is movable between at least a no-contact configuration and a contact configuration with the tracks (105), and which is configured to be moved between said configurations by each of the mechanical mechanisms (4).

4. The device of claim 3, wherein the mechanical mechanisms (4) comprise at least a plate body (200) arranged in at least an elastically yielding material associated to the plate (104) such as to cover the conductive element (106), and provided that at least two free flaps, defining the mechanical mechanisms (4) and configured such that each to come into contact with the conductive element (106).

5. The device (101) of claim 3, wherein the conductive element (106) is associated to the plate (104).

6. The device (101) of claim 3, wherein the device comprises a plurality of conductive elements (106) which are supported by the plate (104).

7. The device (101) of claim 6, wherein the conductive element (106) comprises at least a conductive filament (107) which is superiorly associated to the plate (104) at an intermediate zone (107a) of the plate (104), the intermediate zone (107a) being defined between two ends (107b) and defines two tracts (107c) which diverge from the intermediate zone (107a) and which are separated from the plate (104) by an elastic member (108), each of the mechanical mechanisms (4) being configured to contact at least one of the ends (107b) in order to move the respective tract of the filament (107) from the no-contact configuration to the in contact configuration, in opposition to the elastic member (108).

8. The device (101) of claim 7, wherein a projection of the end (107b) of each tract (107c) of the filament (107) on a plane defined by the plate (104) is external to the plate (104).

9. The device (101) of claim 7 wherein the elastic member (108) comprises at least a flexion spring, having a plurality of leaves, each leaf of the flexion spring being formed by each of the tracts (107c) of the filament (107), the filament (107) comprising at least a coil (109) in the intermediate area (107a).

10. The device (101) of claim 7, further comprising at least a protective bridge (110) which is solidly associated to the plate (104) at the intermediate zone (107a) of the filament (108).

11. The device (101) of claim 10, wherein the bridge (110) comprises engaging members (111) that engage with the plate (104).

12. The device (101) of claim 7, wherein the conductive element (106) comprises a pair of conductive filaments (107) which are superiorly associated to the plate (104) and are arranged with respective longitudinal axes thereof substantially parallel.

13. A monitoring unit (1) for locating animals, comprising a box body (2) configured to contain the animals and provided with at least one access port (3) and mechanical mechanisms (4) configured to open and close the access ports (3), wherein the monitoring unit (1) comprises at least a device (101) configured to signal a presence of animals inside the box body (2) as claimed in claim 1, activatable by mechanical mechanisms arranged internally of the box body.

14. The monitoring station (1) of claim 13, wherein the box body comprises at least two access ports (3) comprising at least a tunnel (6) which is provided with a first access mouth (7) to the tunnel (6), and with a second access mouth (8) which faces towards an interior of the box body (2), the mechanical mechanism (4) being activatable to selectively open the first access mouth (7) and the second (8) access mouth and comprising at least an inclined plane (9) which is interposed between the first and the second access mouths and which is tiltingly associated to lateral walls of the tunnel (6) at a central pivot (10), a first end (9a) of the plane (9), which is proximal to the second access mouth (8), being configured to contact a switch element (103) at an opening of the second access mouth (8).

15. The monitoring unit (1) of claim 13, wherein the unit (1) it is a trap comprising a no-return mechanism, configured to prevent an animal from leaving the box body (2).

16. The monitoring unit (1) of claims 15, wherein the no-return mechanism comprises at least a counterweight (11) which is associated to the plane (9) at a second end (9b) thereof, and which is positioned opposite the first end, for closing the second access mouth (8).
